(19) United States
(12) Patent Application Publication
(10) Pub. No.: US 2008/0208725 A1
(43) Pub. Date: Aug. 28, 2008

(54) System and method facilitating private currency

(76) Inventors: Roger Hoy, (US); John Dennis, (US); Doug Merryman, (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/069,570

(22) Filed: Feb. 11, 2008

Related U.S. Application Data
(60) Provisional application No. 60/900,803, filed on Feb. 9, 2007.

(51) Int. Cl. G06Q 40/00

(52) U.S. Cl. 705/35

(57) ABSTRACT

Computer-based systems and methods for facilitating private currency. Merchants who desire to use private currency participate in a merchant network wherein network members agree to accept private currency. Consumers are provided with a consumer account that may include both a private currency account and a commodities account. Consumers are provided with the ability to pre-set options allowing them to automatically refill a private currency account or commodities account while continuing to use goods and/or services purchased using currency or units stored in the consumer account.

### RELATED APPLICATION

This patent application claims the benefit of U.S. Provisional Patent Application No. 60/900,803, filed on Feb. 9, 2007, which is hereby incorporated by reference in its entirety.

### FIELD OF THE INVENTION

The invention relates generally to alternative forms of currency and, more particularly, to a form of private currency for use with a network of providers of goods and services.

### BACKGROUND OF THE INVENTION

In recent decades, the form, function, and uses of currency have changed drastically. In the past, consumers and merchants were limited to using national currencies in the form of cash, or paper checks that represented amounts that existed in associated bank accounts. In recent years, alternative methods of representing and exchanging currency have changed how consumers and merchants interact. One representation of such a method is the use of electronic representations of currency. Typically in electronic currency transactions, a buyer of a good or service holds some form of an electronic medium that includes a representation of an account number that represents a bank or credit account. Merchants, who sell goods or services, are typically equipped with some device or method capable of reading the electronic medium which provides information relating to the associated account. This allows the merchant to determine whether or not a particular consumer is authorized to make a particular purchase. The merchant is able to determine if a consumer's associated account is valid, and whether or not the consumer has sufficient resources available to participate in a particular transaction.

In recent years, credit and debit cards have become the predominant form of electronic currency used in transactions. A card user's information, including an associated account number, is typically stored on a magnetic strip card. Only a small number of credit card networks exist which provide a means for the cards to be used at a variety of merchants. Examples of credit card network providers are: Visa, Mastercard, American Express, Discover, and Diner's Club. In order for a merchant to collect payment for goods or services purchased using a card, the merchant collects account information associated with the card using a card reader or by documenting associated account numbers. This information allows the merchant to collect, through the credit card network associated with the card, the transaction amount. In order to collect, the merchant reports a claim in the transaction amount to the card provider, and the card provider reimburses the merchant for the transaction amount from the user's account, minus a transaction fee. Transaction fees are typically 1-3% of the transaction amount for larger merchants and 3-6% of the transaction amount for smaller merchants, thus increasing a merchant's cost of providing customers with goods or services. Furthermore, because the merchant is not automatically compensated for the transaction amount, disputes over transactions often arise. When such a dispute arises, merchants must typically go through complicated procedures to be reimbursed for the transaction amount due them, thus again increasing the merchant's cost of providing customers with goods or services.

Other aspects of credit cards in particular also prove detrimental to many consumers. First, many consumers are incapable of acquiring such a card. Many consumers do not have the established credit to acquire a credit card. This is detrimental, because many would be consumers of goods or services, for which the only acceptable payment method is an account number associated with a form of electronic currency, are unable to purchase these goods and services. Examples are goods and services acquired over telephone or the internet. Many consumers are entirely excluded from certain markets due to these limitations. This damages both consumers who cannot acquire desired goods or services, and merchants who cannot deliver goods or services desired by these consumers.

The use of credit or debit cards are further undesirable over the use of cash in that they eliminate the privacy inherent in using cash to purchase goods or services. As previously mentioned, the use of such cards requires an associated account number. Typically, acquisition of a credit or debit card requires disclosure by the user of the card personal information such as name, social security number, associated bank account numbers, and the like. When such a card is used, this personal information is subject to theft, commonly referred to as identity theft. If someone comes into possession of another's account number associated with that card, they may potentially find ways to make purchases using that information without the knowledge of the actual user. Although banking institutions that issue such cards typically provide compensation, re-acquiring stolen funds or property is often a stressful and intricate process.

Furthermore, the use of credit or debit cards carries a disadvantage compared with the use of cash in that a record of the credit card user's account number, and perhaps their name and other associated information, is often recorded along with detail of a particular transaction. The requirement of personal information may be due to preferences of the provider of the card or due to government regulations. Consumers, for various reasons, often wish to make purchases anonymously, as is possible with cash payments. One example is where a husband and wife share a common card account, and one spouse wishes to surprise another with a gift that may only be purchased using the card. However, when a credit or debit card is used a verifiable record of a particular transaction is created. This often limits consumer's purchases from merchants that provide goods and services on the phone or internet or other markets that do not accept cash payments.

One existing solution to the use of bank authorized credit or debit cards as a form of electronic currency is in pre-paid cards. Pre-paid cards resemble traditional credit or debit cards in that they are provided by the same card networks as credit or debit cards, such as Visa, Mastercard, American Express, Diner's Club, etc. In order to acquire such a card, a potential user may pay a fee to acquire a magnetic strip card. The user is then exchanges some form of currency for value added to the card. Once the value runs out, the user then either discards the card or adds additional value to it.

Because pre-paid cards are provided through the same network providers as traditional credit or debit cards, merchants who accept these cards still suffer the detriments associated with traditional cards. Merchants are still charged a significant transaction percentage when compensated for a transaction amount, and issues related to settlement of transaction claims results in significant costs to merchants. These costs are often passed on the consumers in the form of higher prices.

Many pre-paid cards also fail to provide the level of privacy in consumer transactions that is typically available with cash. These pre-paid cards are associated with the previously mentioned limited providers of card services. Many of these providers require personal information in order to create a pre-paid account, either because of provider practices or government regulations. As a result, consumers remain unable to make anonymous purchases using electronic currency.

It is commonly known that telephones are a dominant form of communication in today's world, both using traditional hard wired telephones and mobile cellular telephones. There are many methods by which users access the ability to make or receive telephone calls. Some users of telecommunications services purchase plans, by which they pay a fixed fee to make phone calls. Some of these fixed fees cover a specific type of telecommunication, such as local telephone calls. Others cover long distance calls, or the use of a mobile phone. In some circumstances, a user pays a fixed fee that covers a certain amount of calls, and if a user exceeds that preset amount his or her account is charged more for the access. In many cases, this access can result in substantial cost. In other cases, when using a payphone the user must enter currency into the phone. For both these circumstances, many consumers of telecommunications services choose to purchase pre-paid amounts of telecommunications units. These consumers purchase an amount of telecommunications units for a particular application, such as for use in making long distance calls or in operating a mobile phone, or telecommunications units that cover all types of phone uses. In certain cases, the cost of using such telecommunications time is much less than the cost of the same time when used in a fixed fee plan.

In exchange for purchase of pre-paid telecommunications time, or telecommunications minutes, a consumer is given an account number in exchange for currency. The user of the telecommunications minutes can then use the minutes by entering the account number through various means, including entering the number into a land line telephone, a pay telephone, or a cellular telephone. In other circumstances, the telecommunications time is provided to the user through a form of electronic medium that stores the account number and/or associated value, such as a magnetic strip card. The electronic medium can then be used to activate a phone and place or receive a call. In most cases, when the balance of telecommunications units in the account falls to zero, the user must then get a new pre-paid card or refill the card. Typically, the user must either visit a merchant or dial a telephone number or access a website to refill the account.

One disadvantage of using pre-paid telecommunications units, as opposed to using a plan, is that the user only has a limited amount of time to make a particular call. Often, when placing a call, a user does not know beforehand how long he or she plans to talk. In many cases, a user is in the midst of a call when the available units run out. Because the user is unable to refill or purchase more communications time during the call, the telephone call is cut off prematurely. The user must then refill or repurchase telecommunications units, and replace the call, or not complete the conversation.

Therefore, a need exists to provide a private currency alternative for consumers to purchase goods and services that are provided in exchange for electronic currency such as credit or debit cards. Further, a need exists to provide an alternative for user's of pre-paid telecommunications services such that a telecommunications account may be automatically updated while a user remains on a call.

### SUMMARY OF THE INVENTION

According to one aspect of the invention, a private form of currency is provided that allows consumers the ability to purchase goods and services that typically only accept electronic forms of currency, allows merchants to complete electronic transactions without the detriments provided by traditional forms of electronic currency such as credit, debit, and pre-paid cards, and allows users protection from identity theft and privacy as to the goods or services they purchase.

According to one embodiment, a network of member merchants is provided. Each member of the network agrees to accept the private form of currency in exchange for goods and services. In one embodiment, network members provide that the cost of goods and services is in the form of the private currency in lieu of national currency. In various embodiments, network members are provided with a means to validate and accept purchases from consumers who possess private currency. In various embodiments, network members are provided an account number through which they can transact with the provider of the private currency in order to redeem the electronic currency in the form of cash. In various embodiments, network members can redeem the private currency as any form of currency. In various embodiments, network members can redeem the private currency in any national currency.

According to various embodiments, consumers are provided with the ability to use traditional means of currency transfer to purchase the private currency. Some examples of traditional forms of currency include: cash, credit, credit cards, debit cards, pre-paid debit cards, or electronic funds transfers. The consumer may set up an account with the provider of the private currency. The consumer is assigned an account number that is associated with the consumer's account. In various embodiments, the consumer is provided a physical electronic medium that represents the user's account number. In one embodiment, the user is provided with a magnetic strip card that holds the user's account number. In other various embodiments, the magnetic strip card may hold additional information.

In various embodiments, a consumer who possesses private currency may use that currency to purchase goods or services from members of the merchant network. Consumers may be able to earn private currency using the private currency they originally purchased. Consumers who possess unused private currency may redeem unused currency for any other form of currency. Consumers who possess unused private currency may redeem that currency in the form of any national currency. If a consumer increases the value of private currency while using a network member merchant's goods and/or services, the user may then redeem the additional value of the currency.

In various embodiments, a consumer account includes both a private currency account and a commodities account. The user is provided with options to pre-configure automatic refill of private currency from an associated bank account, or automatic refill of commodities units from a private currency account. For example, the commodity account may be a telecommunications unit account. A user may place a telephone call using the telecommunications units. When the telecommunications units fall below a pre-set threshold, the telecommunications units are refilled from the private currency account. Optionally, when the private currency falls below a threshold amount, private currency is refilled from an associated bank account. Thus, the consumer is able to use pre-paid telecommunications providers without ending a telephone call prematurely.

### BRIEF DESCRIPTION OF THE DRAWINGS

The invention may be more completely understood in consideration of the following detailed description of various embodiments of the invention in connection with the accompanying drawings, in which:

FIG. 1 illustrates a system and method of private currency used by both merchants and consumers.

FIG. 2 illustrates a merchant's use of private currency according to aspects of the invention.

FIG. 3 illustrates transaction rules available to merchants when using private currency in accordance with aspects of the invention.

FIG. 4 illustrates a consumer's use of private currency in accordance with aspects of the invention.

FIG. 5 illustrates portions of a consumer account in accordance with aspects of the invention.

FIG. 6 illustrates a use of a commodities account as a telecommunications unit account in accordance with aspects of the invention.

FIG. 7 illustrates options available to consumers when using a consumer account including private currency in accordance with aspects of the invention.

FIG. 8 illustrates automatic updating of telecommunications units from a private currency account in accordance with aspects of the invention.

FIG. 9 illustrates generally automatic updating of private currency from an associated bank or credit account in accordance with aspects of the invention.

FIG. 10 illustrates a system of private currency according to one embodiment of the invention.

FIG. 11 illustrates various options for private currency redemption available to merchants and consumers in accordance with aspects of the invention.

FIG. 12 illustrates generally an example of a computer system on which aspects of the present invention can be implemented.

FIG. 13 illustrates generally an example of a computer network on which aspects of the present invention can be implemented.

FIG. 14 illustrates generally an example of a client-server network on which the invention can be implemented.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

The invention may be embodied in other specific forms without departing from the essential attributes thereof; therefore, the illustrated embodiments should be considered in all respects as illustrative and not restrictive.

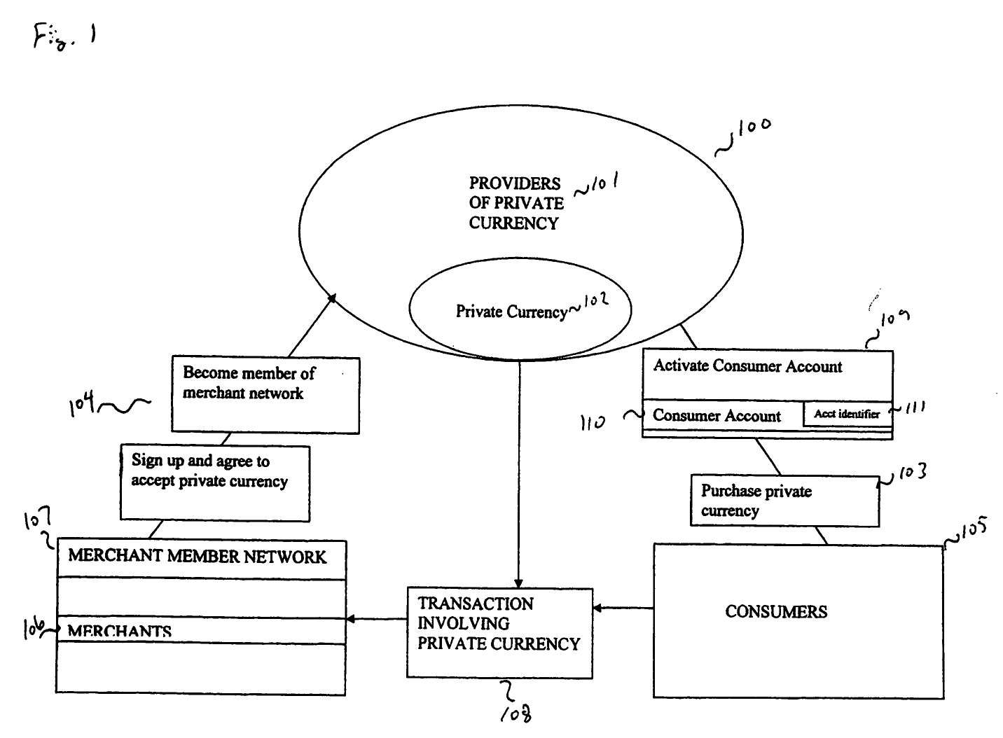

FIG. 1 illustrates generally an example of the use of private currency as disclosed herein. At 100, a provider of private currency 101 makes available a private currency 102 for use by both merchants 106 and consumers 105. At 109, a consumer 105 establishes a consumer account 110 with the provider of private currency 101. In various embodiments, when an account is established, the user is provided with an account identifier 111. In one embodiment, the account identifier 111 is an account number. In some embodiments, the consumer 105 is provided an electronic representation of the account identifier 111. In one embodiment, the electronic representation of the account identifier is a magnetic strip card. In other embodiments, the electronic representation can be any means by which someone can identify a user account, for example a SIM card, an electronic magnetic disc medium, a flash drive, a USB drive, an SD card, or any electronic representation of an account number, such as the number itself stored in computer memory, or by the user entering an account number into a website.

At 103, consumers 105 purchase private currency 102 from the private currency provider 101. At 104, merchants 106 agree to become members of a merchant member network 107. Merchant 106 members of the merchant network 107 agree to accept the private currency 102 in exchange for goods and/or services. In various embodiments, private currency 102 has a value independent of the value of any particular national currency. In various embodiments, private currency 102 is a commodity with a value. In various embodiments, members of the merchant member network 107 offer beneficial pricing over alternate forms of currency to consumers 105 when consumers 105 use private currency 102 to purchase goods and/or services, similar to a coupon. At 108, a transaction occurs where consumers exchange private currency 102 for goods and/or services provided by a merchant 106 that is a member of the merchant network 107. In various embodiments, the providers of the private currency 101 may act as an intermediary between merchants 106 and consumers 105 to facilitate a transaction involving private currency 102. In certain embodiments, the provider of private currency 101 also provides a transaction platform through which a network member merchant 106 and a consumer 105 complete a transaction involving private currency 102. In these embodiments, when the consumer 105 desires to make a purchase, the consumer 105 visits a webpage. In various embodiments, the webpage may be a standalone webpage, a link from the network member merchant's webpage, or a part of the network member merchant's webpage. In various embodiments, the consumer 105 selects desired goods and/or services from the merchant's 106 webpage. In an embodiment, information provided by the consumer, such as an account number for the consumer's account with the provider of private currency 101, is transferred to the transaction platform. In an alternate embodiment, information provided by the consumer is directly entered into the transaction platform. In various embodiments, the transaction platform facilitates the transaction between the consumer 105 and the merchant 106.

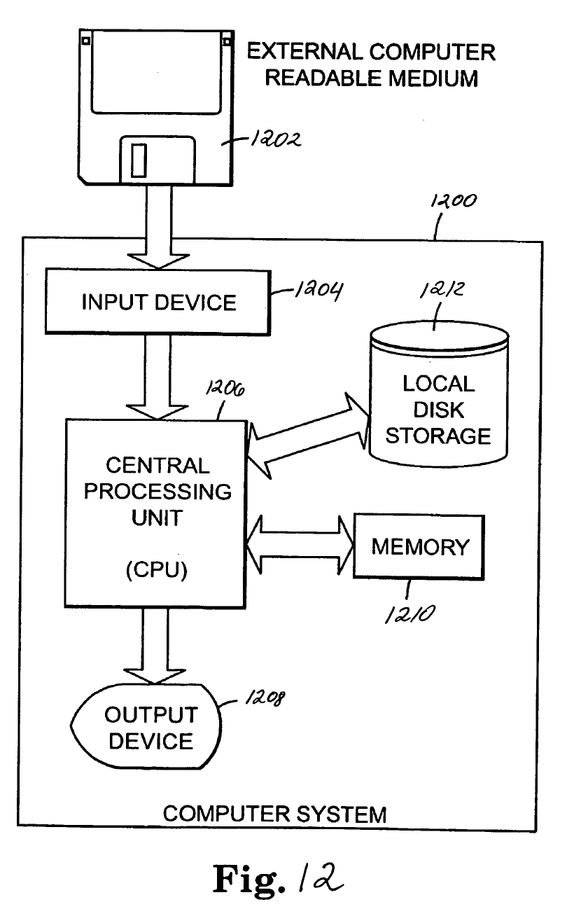

The present invention can be realized in a number of embodiments, including one or more realizations in hardware, in software/firmware, and in a combination of hardware and software/firmware. When realized in software or firmware, the present invention can include several main components which are each a software program. The main software program components run on one or more computer systems. In one embodiment, each of the main software program components runs on its own computer system. FIG. 12 illustrates one embodiment of a computer system 1200 and an external computer readable medium 1202 which can be employed according to the present invention to implement one or more of the main software program according to the present invention. Embodiments of external computer readable medium 1202 include, but are not limited to: a nonvolatile memory, a CD-ROM, a floppy disk, and a disk cartridge. Any one of the main software program components according to the present invention can be implemented in a variety of compiled and interpreted computer languages. External computer readable medium 1202 stores source code, object code, executable code, shell scripts and/or dynamic link libraries for any one of the main software program components according to the present invention. An input device 1204 reads external computer readable medium 1202 and provides this data to computer system 1200. Embodiments of input device 1204 include but are not limited to: a USB port, a CD-ROM reader, a floppy disk drive, and a data cartridge reader.

Computer system 1200 includes a central processing unit 1206 for executing any one of the main software program components according to the present invention. Computer system 1200 also includes local disk storage 1212, which is a computer readable medium for locally storing any one of the main software program components according to the present invention before, during, and after execution. Any one of the main software program components according to the present invention also utilizes memory 1210, which is a computer readable medium within the computer system, during execution. Upon execution of any one of the main software program components according to the present invention, output data is produced and directed to an output device 1208. Embodiments of output device 1208 include, but are not limited to: a computer display device, a printer, and/or a disk storage device.

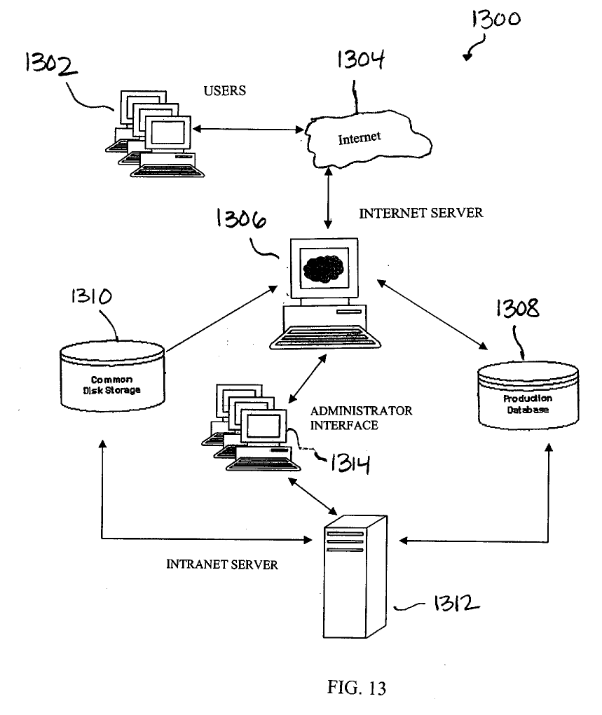

FIG. 13 illustrates an example of a computer network system 1300 in which the present invention can be implemented. Users of the present invention, including both merchants and consumers, can utilize any suitable computer having access to internet 1304 via web browser software. Internet server 1306 manages communications sessions each user 1302. Also, internet server 1302 executes any software associated with the present invention. In one embodiment, the data relating to the present invention is stored in and accessed from production data base 1308. Common disc storage 1310 stores application program instructions, and related data associated with the present invention.

To facilitate system development, maintenance, and customer service, an intranet server 1312 is interfaced with production database 1308 and 1310. For development, an off-line applications associated with the present invention can be run on intranet server 1312. A maintenance application can run on intranet server 1312 that permits establishment of, for example: new consumer or merchant accounts, rules associated with transactions, and or information relating to associated bank accounts, private currency, or commodities. Intranet server 1312 can also interface with or execute at least a portion of the applications associated with the instant invention while permitting a customer service provider to help users complete their transactions.

Administrator interface 1314 can communicate selectively with internet server 1306 or intranet server 1312 to permit the uniform provider to monitor, maintain, reconfigure, or use system 1300.

In a related embodiment, system 1300 can also run related applications. Processing of these applications can take place, as appropriate, at internet server 1306 or intranet server 1312.

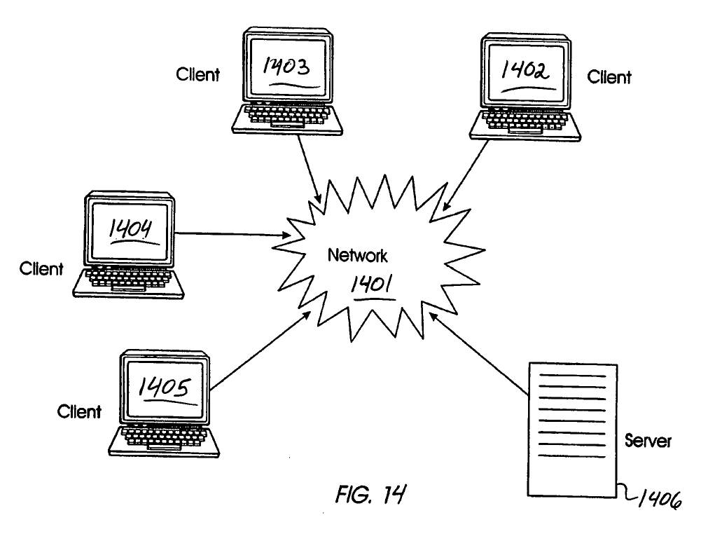

FIG. 14 illustrates generally a client-server network on which the present invention might be practiced. It includes a server 1406 connected to a network 1401. The network could be any type of network like Local Area Network, Internet and the like. Also present on the network are different clients 1401, 1402, 1403, 1404, and 1405. The interconnection between different clients on the network could be by any known communication means such as wired means, radio links or by infrared transmissions. The networking topology could be any known topology such as star, linear, ring and the like or a combination of any of these. The clients and the server could use any of the known communication protocols such as TCP/IP, Ethernet and the like for communication. The number of servers and the clients is not limited and the data could reside either on one server or could be distributed over a number of servers. The server 1406 acts as the service provider and clients send requests to the server for availing the services provided by it. The clients might themselves be the customers 1402 1403 or two or more clients might belong to one customer 1404, 1405. The enforcement of SLA may be required between the service provider i.e. the server 1406 and each customer.

The clients 1402, 1403, 1404, or 1405 could be electronic devices like personal computers, mobile phones, interactive televisions and the like, being operated by humans or they could also be software agents running on electronic devices on behalf of individuals or organizations.

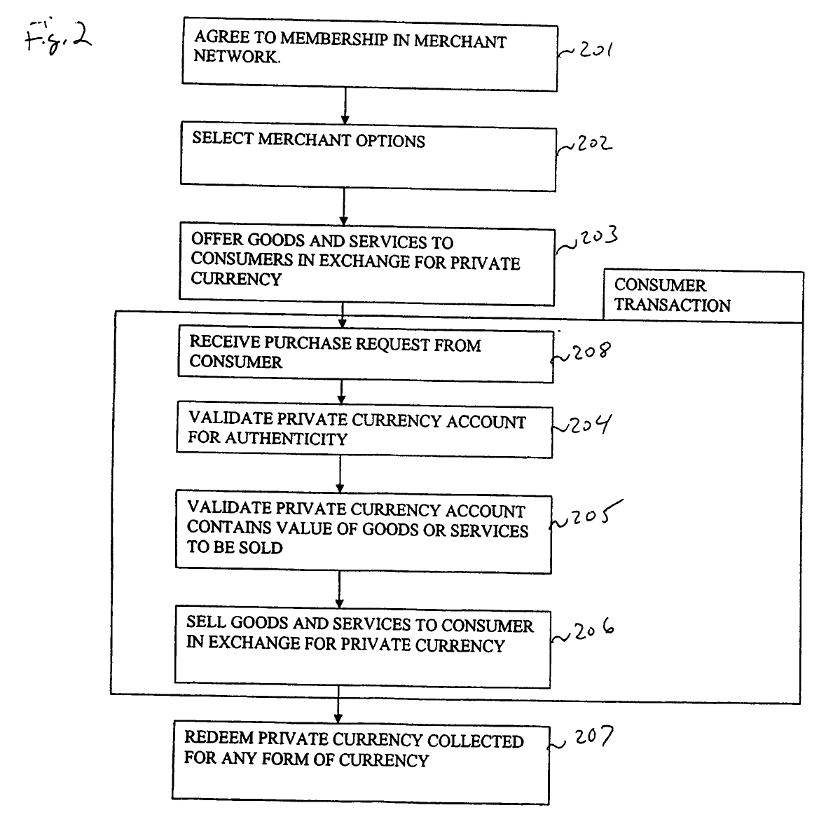

FIG. 2 illustrates generally the use of private currency 101 for merchants 106. First, at 201, a merchant 106 makes an agreement with the provider of private currency 101 to become a member of the merchant member network 107. Next, at 202, a merchant 106 is provided with one or more options to setup rules that control the use of private currency 102 in exchange for goods and/or services from the merchant 106. Next, at 203, the merchant 106 offers goods and/or services that may be exchanged for private currency 102. In various embodiments, the merchant 106 only accepts private currency 102 in exchange for goods and/or services. In alternative embodiments, the merchant 106 accepts either traditional forms of currency or private currency 102 in exchange for goods and/or services. In other embodiments, the merchant 106 may accept a combination of private currency 102 and traditional forms of currency in exchange for goods and/or services.

Next, at 208, a consumer initiates a consumer request to purchase goods and/or services from the merchant 106. In various examples, the consumer request may be entering information into a website, requesting goods over the telephone, or any other form of communication between the consumer 105 and the merchant 106. At 204, the user account 110 associated with the private currency 102 is subjected to a validation procedure to establish that the user account 110 is authorized by the providers of private currency 101. At 205, the merchant 106 further validates the user account 110 to ensure that a sufficient amount of private currency exists such that the merchant 106 is willing to proceed in transacting with the consumer 105 to exchange private currency 102 for goods and/or services. In some embodiments, the provider of private currency 101 verifies the validity of the consumer account instead of the network member merchant 106. Next, at 206, once both the merchant 106 and the consumer 105 authorize the transaction, the goods or services are transferred to the consumer 105 by the merchant 106. In various embodiments, when the provider of private currency 101 acts as an intermediary between the merchant 106 and the consumer 105, the value of the private currency 102 is exchanged by the provider of private currency to any alternate form of currency, and the merchant receives such alternate currency in exchange for the goods and/or services. The alternate form of currency may be any currency agreed upon between the merchant 106 and the provider of private currency 101. Alternatively, the alternate form of currency may be selectable by the merchant 106 for each particular transaction, or for a group of transactions. In other various embodiments, the merchant 106 may accept private currency 102 alone in exchange for the goods and/or services. In these embodiments, at 207, the merchant 106 then redeems with the provider of private currency 101 the private currency 102 it received from the consumer 105 in exchange for an alternate form of currency.

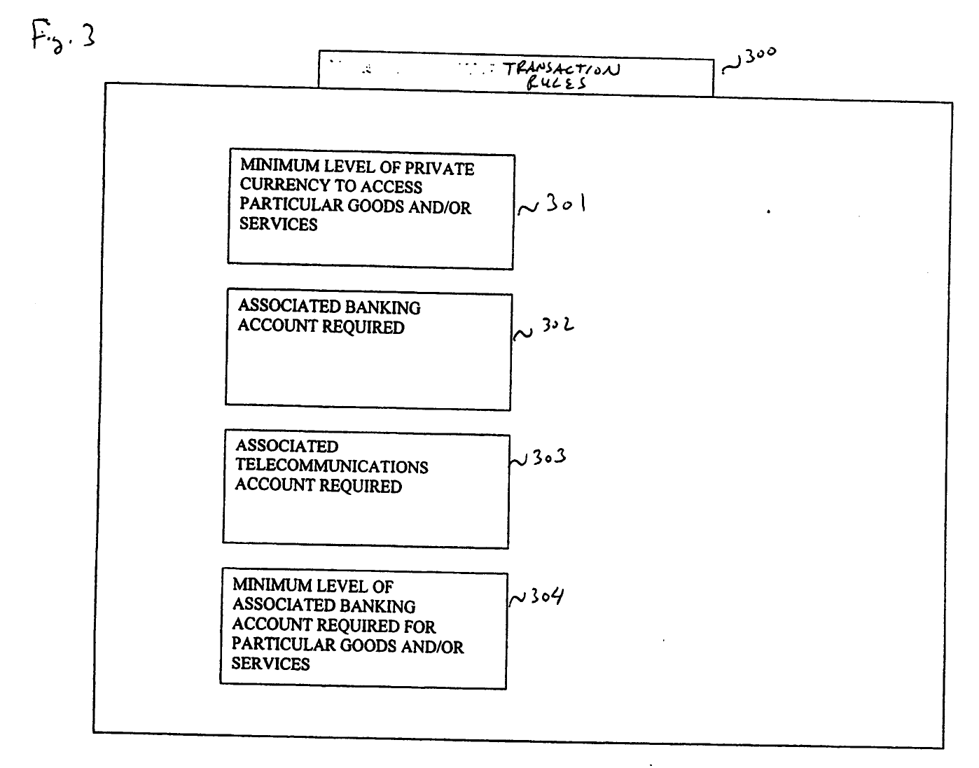

FIG. 3 illustrates generally the options provided to a merchant 106 to set up transaction rules 300 that regulate transactions. The rules may be set up when the merchant 106 sets up a new account, when the merchant 106 authorizes a specific transaction with a consumer 105, when the merchant redeems private currency 102 in exchange for an alternate form of currency, or at any time when the merchant contacts the provider of private currency 101 to modify one or more rules. In one embodiment, the merchant 106 is provided the option to set up a rule that sets a minimum level of private currency necessary to access goods and/or services 301. In various embodiments, the merchant 106 is provided the option to set up a rule regulating all goods and/or services offered by the merchant, each particular good and/or service offered by the merchant 106, groups of goods and/or services offered by the merchant 106, or for specific transactions or specific consumers 105. In another embodiment, the merchant 106 is provided the option to set up a rule requiring that a consumer account be associated with institutional bank account 302. In various embodiments, this rule may require that a consumer's private currency account be associated with a recognized banking institution. In various embodiments, this rule may require that a consumer's private currency account be associated with a particular banking institution or group of banking institutions. The particular banking institutions may be specified by the merchant itself or by any external source. In another embodiment, the merchant 106 is provided the option to set up a rule requiring that a particular level of currency exists in a consumer's associated banking account 304. In various embodiments, the merchant 106 is provided the ability to regulate the requirement of a banking account or level of a banking account for specific goods and/or services, groupings of goods and/or services, or particular consumers. These requirements may also depend on the consumer credit rating of a particular consumer. In another embodiment, the merchant 106 is provided the option to set up a rule requiring that a consumer's private currency account be associated with a telecommunications account 303. In various embodiments, this rule may require that a consumer's private currency account be associated with a particular telecommunications account or group of telecommunications accounts. The particular telecommunications account or accounts may be specified by the merchant itself or by any external source.

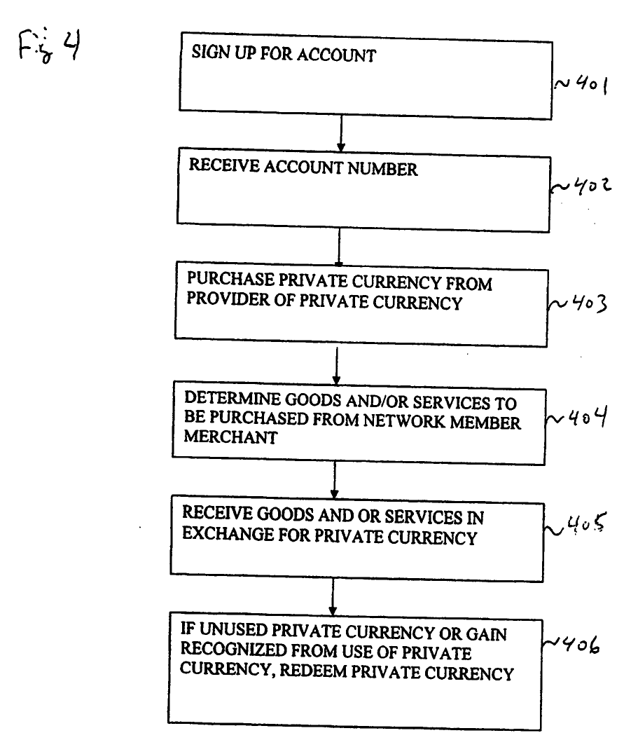

FIG. 4 illustrates generally the use of private currency 102 for a consumer 105. First, at 401, a consumer sets up a consumer account with the provider of private currency 101. At 402, as discussed above, the consumer 105 is issued an account number to identify the consumer's account. In various embodiments, the consumer 105 is provided an electronic representation of the account number. Next, at 403, the consumer purchases an amount of private currency. In various embodiments, the amount of private currency received by the consumer is proportional to a ratio with the particular national currency the consumer uses as determined by the provider of private currency 101. At 404, the consumer determines goods and/or services he or she desires to purchase that are offered by a member of the merchant network 107. At 405, a transaction between the consumer and network member merchant occurs, and the consumer receives goods and/or services in exchange for private currency held in the consumer's consumer account. At 406, the consumer is provided the option to redeem private currency on his/her account. In various embodiments, the consumer exchanges private currency for any alternate form of currency, such as a national currency. In various embodiments, the consumer may redeem private currency that exists on the consumer's account. In one example, the consumer may redeem unused private currency. In another example, the consumer may redeem private currency that was earned when participating in a good or service offered by a member of the merchant network.

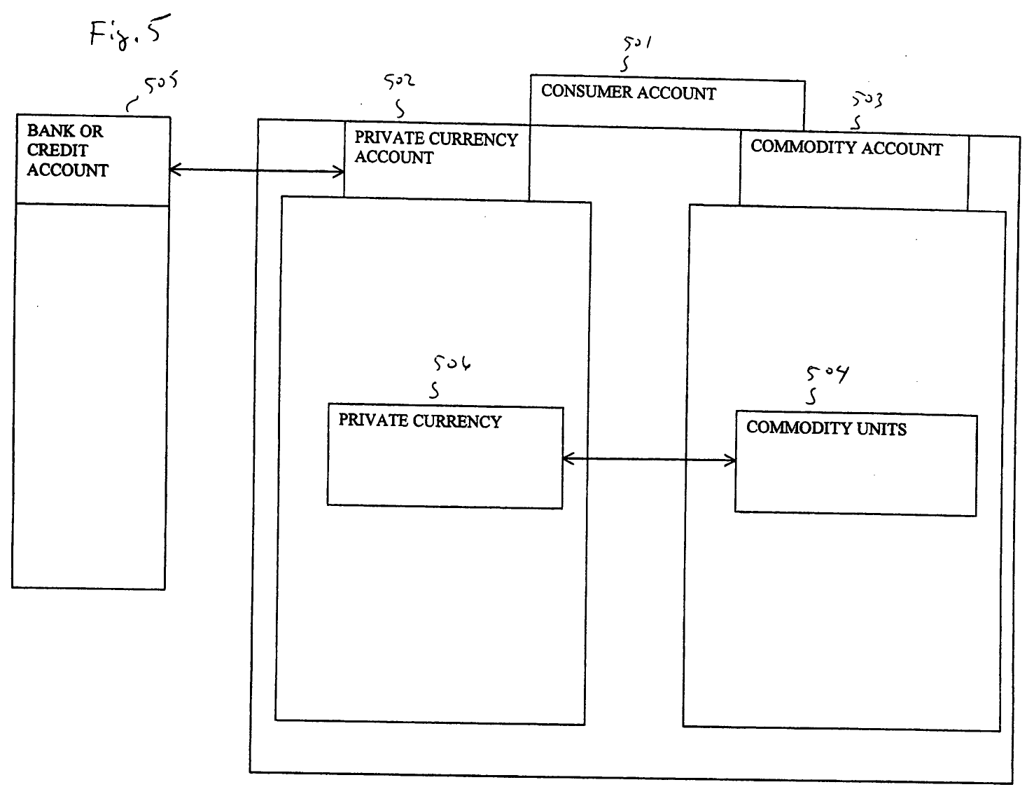

FIG. 5 illustrates generally an embodiment of a multiple use consumer account with the private currency provider. In various embodiments, the consumer account 501 includes a private currency account 502 as disclosed herein. In various embodiments, the consumer account also includes commodity account 503. Also included in FIG. 5 is a bank account or credit account 505 associated with the consumer account 501. In one embodiment, the commodity account 503 allows access to a single commodity provider. In other embodiments, the commodity account 503 allows access to a variety of commodity providers. In various embodiments, the commodity account 503 includes access to several commodities that the consumer may choose from for a particular transaction. In various embodiments, the commodity is telecommunications minutes. In one embodiment, the telecommunications units are long-distance phone access units. In another embodiment, the telecommunications units are mobile or cellular phone units. In various embodiments, the commodity account may include several options for telecommunications units, including but not limited to: domestic long distance or mobile telecommunications units, international long distance or mobile telecommunications units, or country to country specific telecommunications units. In a specific embodiment, a consumer with such a dual function account may purchase commodity units 504 for the commodity account 503, such as telecommunications units, in exchange for private currency 506 held in the private currency account 502 associated with the consumer account 501.

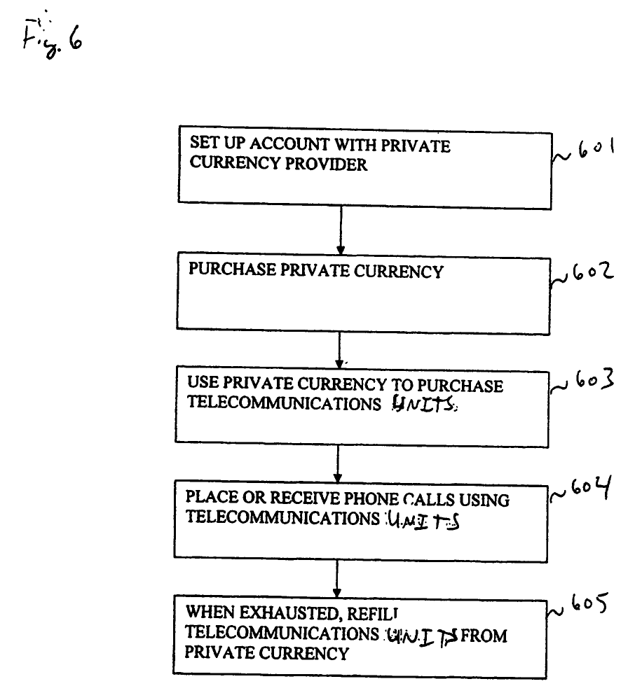

FIG. 6 illustrates generally the operation of a multiple use consumer account. In this example, telecommunications units are provided as an example of a commodities account. Telecommunications units are provided for exemplary purposes only, and should be understood to be non-limiting. Any unit-defined commodity may be used in place of telecommunications minutes. In various embodiments, as discussed previously, a consumer account includes both a private currency account 502 and a telecommunications account. In this example, at 601, a consumer sets up such a consumer account. In one embodiment, the consumer account is associated with a bank or credit account 506. Next, at 602, the consumer purchases private currency from the private currency provider. At 603, the consumer purchases telecommunications minutes in exchange for private currency stored in the account. At 604, the consumer then uses the telecommunications units to place a phone call from a local phone, payphone, or mobile phone. At 605, if the purchased telecommunications minutes are exhausted, the consumer may purchase additional telecommunications minutes from the private currency account.

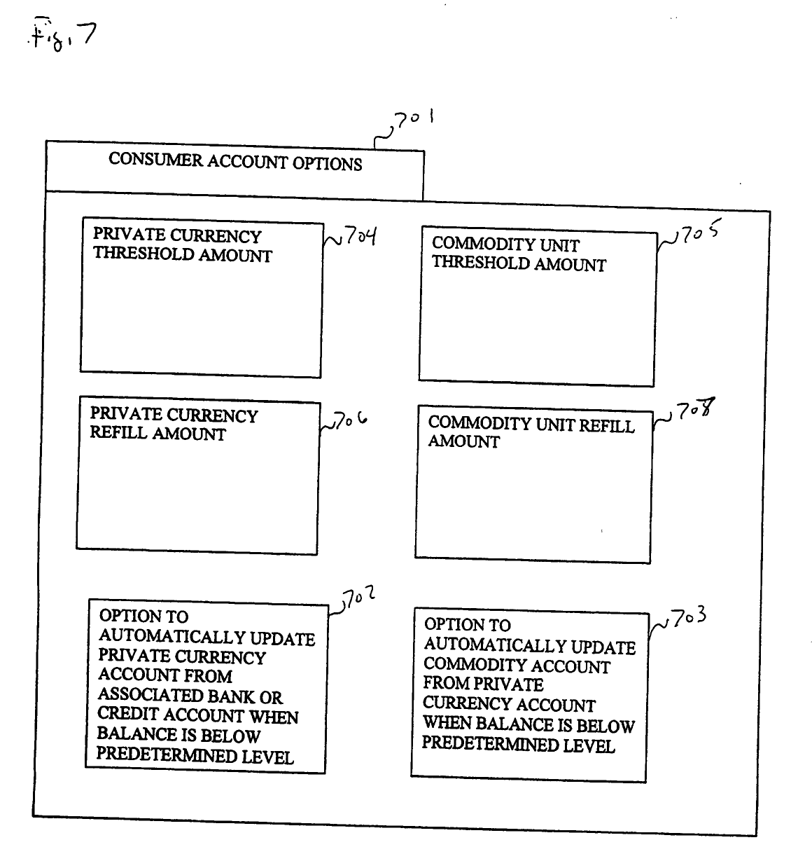

FIG. 7 illustrates examples of consumer account options 701 available to a consumer to regulate a consumer account. In one embodiment, the consumer may setup consumer account options when setting up a consumer account with the private currency provider. In another embodiment, the consumer may set up or change consumer account options 701 at any time by contacting the provider of private currency. In one embodiment, the consumer is provided the option to automatically update his/her private currency account 502 from an associated bank or credit account 702. In various embodiments, the bank or credit account may be provided by an institution external to the provider of private currency, or by the private currency provider itself.

In one embodiment, the consumer is provided the option to set a threshold level of private currency 704. When the private currency account falls below the threshold level, the a funds transfer automatically withdraws funds from the users bank or credit account, which in turn updates the consumer's private currency account. In another embodiment, a consumer is provided with an option to set the amount of funds to be transferred from the associated bank or credit account 706 when the private currency account falls below the threshold amount.

In one embodiment, the consumer is provided the option to automatically update his/her commodity account 503 from the consumer's private currency account 703. In one embodiment, the consumer is provided the option to set a threshold level of commodity units 705. When the commodity account falls below the threshold level, the private currency is withdrawn from the consumer's private currency account, which in turn updates the consumer's commodity account. In another embodiment, a consumer is provided with an option to set the amount of private currency to be transferred from the private currency account when the commodity account falls below the threshold amount 707.

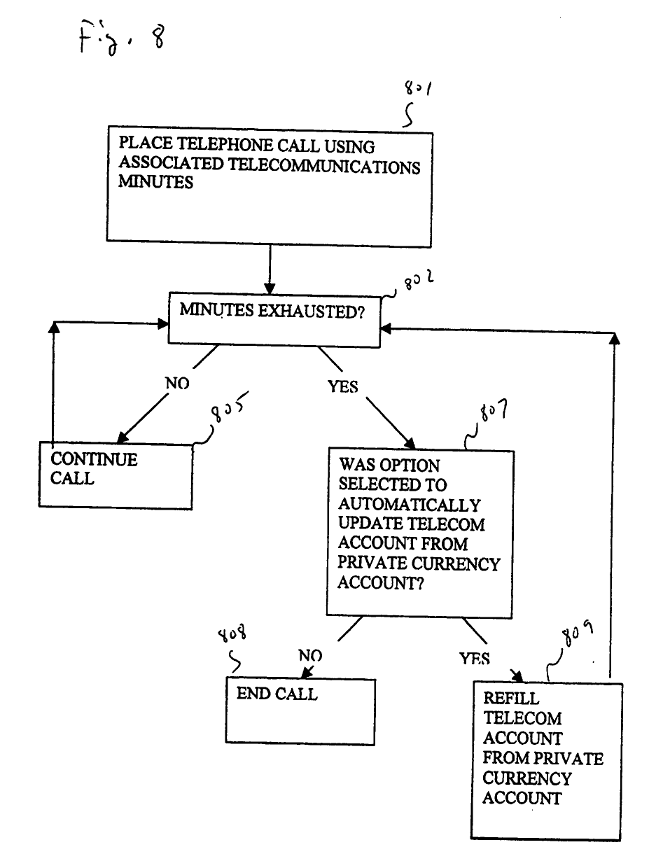

FIG. 8 illustrates generally the use of multiple use consumer account and consumer account options when using a commodity such as telecommunications units. At 801, a user places a phone call using telecommunications units stored in the commodities account. During the call, a system provided by the private currency provider periodically or continually checks the commodities account to determine whether the telecommunications units fall below a threshold 802. At 805, if the telecommunications minutes are have not fallen below a threshold, the call continues. At 807, according to a typical pre-paid telecommunications unit program, when units fall below a threshold the call is ended, perhaps with a notification to the caller. Instead, at 807, if the system determines that telecommunications units are have fallen below a threshold amount, the system then, at 807, determines whether the consumer authorized automatic transfer of private currency from his/her private currency account. If no, at 808 the call is ended as in typical telecommunications unit programs. However, if this option is selected, at 809 the telecommunications units are restored according to pre-configured amounts while the consumer remains on the call.

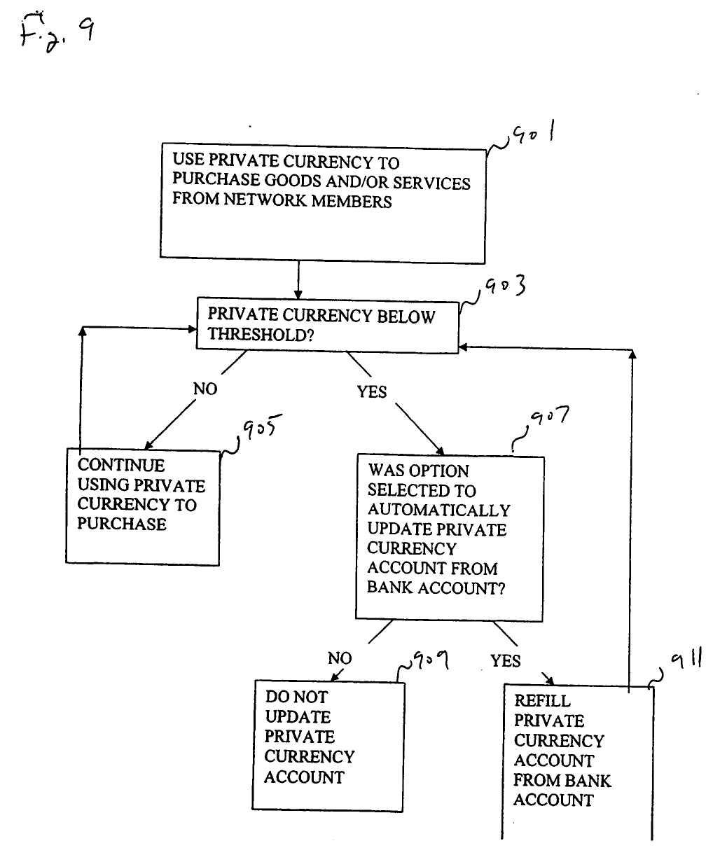

FIG. 9 illustrates generally the use of multiple use consumer account and consumer account options when using private currency to purchase goods and/or services. In this embodiment, a user uses private currency to purchase goods and/or services from a network member merchant 901 as described herein. A system provided by the private currency provider periodically or continually checks the private currency account to determine whether the private currency amount falls below a threshold 903. At 905, if the private currency has not fallen below the threshold, the consumer may continue to use private currency to purchase goods and/or services. At 907, if the system determines that the private currency amount has fallen between a threshold amount, the system then determines whether the consumer authorized automatic transfer of currency from his/her bank or credit account. If no, at 909 the consumer is no longer able to purchase the goods and/or services. However, if this option is selected, at 911 the private currency is restored and the consumer may continue to purchase goods and/or services.

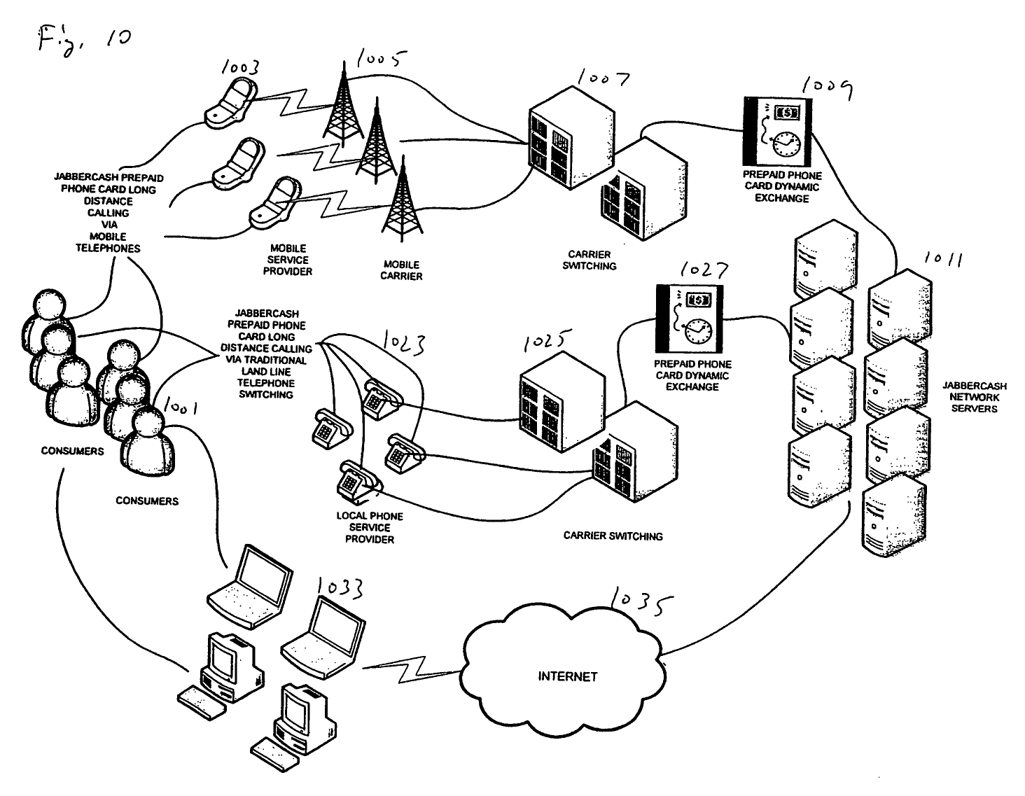

FIG. 10 illustrates generally a system providing for a user account that includes a private currency account and a telecommunications unit account. In this example, a consumer 1001 signs up for an account with the provider of private currency, and purchases private currency as described herein. In one embodiment, the consumer can use the private currency to purchase telecommunications units to be held in an account associated with the consumer's private currency account as described herein. According to this embodiment, the consumer places a telephone call using a mobile phone, wherein mobile phone service is provided by a mobile service provider 1003. According to this embodiment, the consumer's mobile phone communicates with a mobile carrier 1005 to place the call. The call is processed through a carrier switching system 1007. In an embodiment, while the call is in process, as described herein, a pre-paid phone card dynamic exchange 1009 allows the consumer to reload, according to consumer selected preset options, telecommunications units in the user's telecommunications account from the consumer's private currency account. As described herein, the private currency provider's network servers 1011 automatically control the reloading of telecommunications time from the consumer's private currency account, or private currency from the consumer's associated bank account.

In one embodiment, a consumer 1001 signs up for an account with the provider of private currency, and purchases private currency as described herein. In one embodiment, the consumer can use the private currency to purchase telecommunications units to be held in an account associated with the consumer's private currency account as described herein. According to this embodiment, the consumer places a telephone call using a local phone, wherein local phone service is provided by a local service provider 1023. The call is processed through a carrier switching system 1025. In one embodiment, while the call is in process, as described herein, a pre-paid phone card dynamic exchange 1027 allows the consumer to reload, according to consumer selected preset options, telecommunications units in the user's telecommunications account from the consumer's private currency account. As described herein, the private currency provider's network servers 1011 automatically control the reloading of telecommunications time from the consumer's private currency account, or private currency from the consumer's associated bank account.

In another embodiment, the consumer uses a computer 1033 to access goods and/or services provided over the internet 1035. In one embodiment, the consumer uses private currency in the consumer's private currency account to purchase goods and/or services over the internet. In one embodiment, the private currency provider's network servers regulate the transaction between the consumer and network member merchant's as described herein.

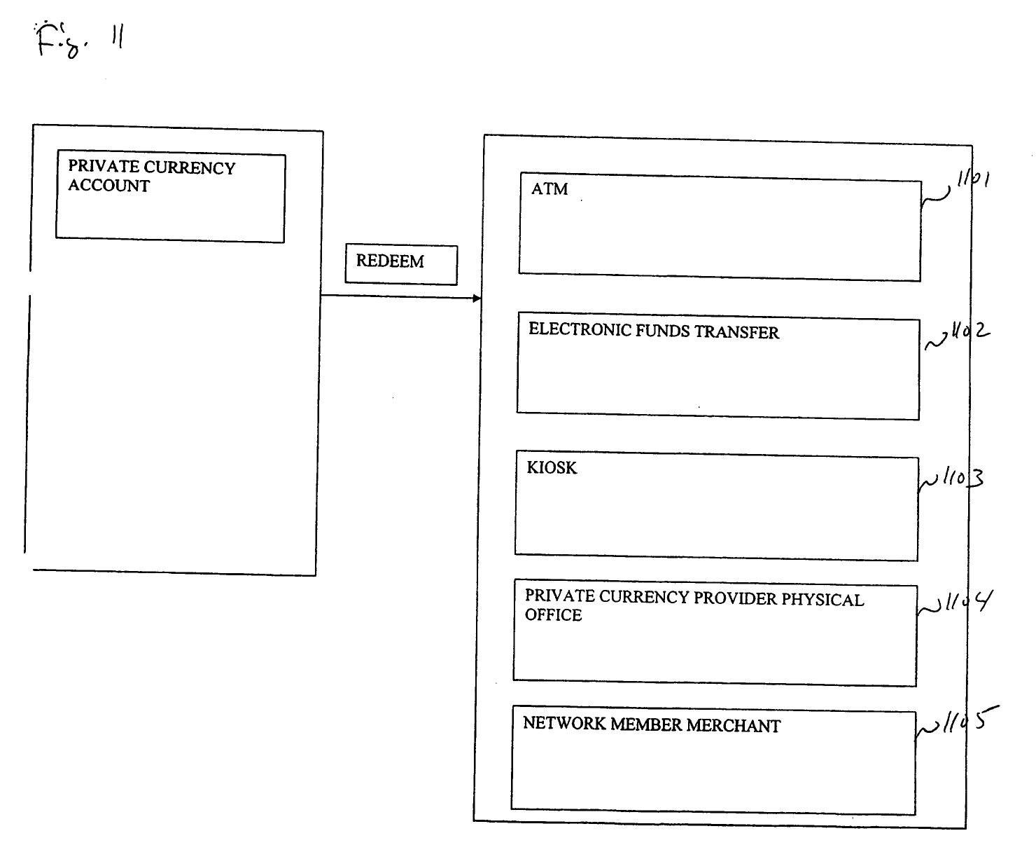

FIG. 11 illustrates generally various embodiments in which network member merchants or consumers can redeem private currency for alternative forms of currency such as national currency. In one embodiment, the private currency provider is associated with an institutional bank, where a consumer or network member merchant are provided a magnetic strip card and associated PIN number, and may redeem private currency in any national currency provided by an ATM 1101. In another embodiment, network member merchants or consumer may redeem private currency through an electronic funds transfer from the provider or private currency 1102. In various embodiments, the provider of private currency may redeem the private currency in any alternative form of currency, such as any national currency, or other forms of alternative currency such as airline or credit card miles.

In one type of embodiment, the provider of private currency also provides one or more kiosks 1103. Kiosks may be similar to an ATM machine but designed specifically to allow redemption of private currency provided by the provider of private currency. In various examples, the kiosk may be used to purchase additional private currency, transfer private currency to another commodity account such as a telecommunications unit account, or to redeem private currency. In another embodiment, the provider of private currency provides a manned physical office 1104. In these embodiments, a network member merchant or consumer may be used to purchase additional private currency, transfer private currency to another commodity account such as a telecommunications unit account, or to redeem private currency. In another embodiment, consumers may redeem private currency at a network member merchant with a physical office 1105. The network member merchant may agree with the provider of private currency to redeem private currency for consumer. The network member merchant then may redeem the private currency received from a consumer according to any of the methods described herein.

What is claimed is:

1. A system for providing private currency as shown and described herein, and its equivalents.

2. A method of providing private currency as shown and described herein, and its equivalents.
